(19) United States
(12) Patent Application Publication
(10) Pub. No.: US 2002/0137569 A1
(43) Pub. Date: Sep. 26, 2002

(54) Coupling arrangement for transmitting a torque

(76) Inventors: Hans-Heinrich Winkel, Uetze (DE); Hermann Lehnertz, Fellbach (DE)

Correspondence Address: Striker Striker & Stenby, 103 East Neck Road, Huntington, NY, 11743, US

(21) Appl. No.: 10/069,701

(22) PCT Filed: Jun. 7, 2001
(86) PCT No.: PCT/DE01/02141

(30) Foreign Application Priority Data
Jun. 24, 2000 (DE) 100 30 930.5

(51) Int. Cl. F16D 3/52; F16D 3/64; F16D 3/78

(52) U.S. Cl. 464/92

(57) ABSTRACT

A coupling arrangement for transmitting a torque is comprised of a drive shaft (1), a driven shaft (5), a damping element (16), which is associated with one of the shafts (1, 5) and is for compensating for an axial offset between the two shafts (1, 5), and a radial tensioning element (4), which is associated with the other shaft (1) and, with the damping element (16), is for introducing a definite force (K) that acts radially on the driven shaft (5).

### PRIOR ART

The invention relates to a coupling arrangement for transmitting a torque between a drive shaft and a driven shaft. A coupling arrangement of this kind should be used, particularly in motor vehicles, when driving auxiliary units such as generators, power steering pumps, air conditioning system compressors, etc.

As the background of invention, it must be emphasized that in internal combustion engines that are conventional at the time of the application, the auxiliary units mentioned are usually driven by means of a belt. Single belts, so-called poly-V-belts, toothed belts, or the like are used for this.

A fundamental property of such belt-driven mechanisms—in addition to the actual stated aim of transmitting a torque—is the transmission of a radial force between the two shafts involved with the belt drive, by means of the belt tension. This belt tension is used to assure is sufficient frictional force between the belt and pulleys so that the involved torques can be reliably transmitted in a manner that is as free of slippage as possible.

In conventional engine designs, the radial force mentioned above is absorbed by the bearing points of the above-mentioned auxiliary units (generator, power steering pump, etc.). The bearing points, of the kind produced, for example, by means of deep groove ball bearings in a fixed-bearing/loose-bearing arrangement, are designed for this exerted radial force and also require a definite axial/radial force in order to achieve the service life specified.

For example to increase the service life of the engine, to reduce maintenance costs, and to reduce the space required by engines, new engine concepts provide for the auxiliary units to be driven without belts. In this connection, the engine provides the auxiliary units with respective driveshafts that have suitable speeds. These shafts are supported in the engine and supply the auxiliary units with a pure torque.

With a purely central drive, therefore, the radial force, which was necessary for the reliable bearing operation of auxiliary units developed for belt drive, is no longer required. This requires changes in the bearing arrangements of the auxiliary units, increases the complexity and therefore also increases the price of the products.

Based on this, the object of the invention is to produce a coupling arrangement for transmitting a torque, with the aid of which conventional auxiliary engine units with conventional bearing points can also be driven by means of a gearwheel drive without a relevant limitation of the service life.

This object is attained by means of the features disclosed in the characterizing part of claim 1. A damping element associated with one of the two shafts is therefore provided in the coupling arrangement in order to compensate for an axial offset between the two shafts. The other shaft is associated with a radial tensioning element, which is coupled to the damping element and introduces a force that acts radially on the driven shaft of the coupling arrangement, which driven shaft is associated with the auxiliary unit. The coupling arrangement thus replaces the radial force exerted by the belt tension in the prior art so that the the bearing points of the auxiliary units are appropriately acted upon even when central drive mechanisms are used and the radial force required for the service life is maintained. As a result, the inexpensive, mass-produced auxiliary units designed for operation with belt drives can still be used even with the new engine concepts with a central drive for the auxiliary units.

In addition to the compensation for axial offset, the damping element mentioned above can advantageously also be used to compensate for angular errors within the coupling arrangement and for tolerances in the axial spacing.

Claim 2 relates to a structurally advantageous design of the radial tensioning element, which is comprised of a driver and a slider that can be adjusted in relation to this driver.

The elastomer damping block disclosed in claim 3 has a double function since in addition to the compensation for axial offset, it simultaneously produces a damping in the transmission of torque.

The embodiment according to claim 4 permits the elastomer damping block to be preassembled with corresponding mounting aids in the form of the slider itself and a mounting plate and then to be efficiently installed in the coupling arrangement.

The embodiment according to claim 5 encourages the long-lasting and reliable exertion of radial force at the bearing points of the auxiliary unit. Namely, a radial force produced by the radial movement of the slider during installation can be obtained by virtue of the fact that the slider is rigidly screw-connected in the appropriate position to the driver supporting it on the one shaft of the coupling arrangement.

A precise definition of the radial force is assured by means of the spring element provided according to claim 6.

Claim 7 relates to a second embodiment of the coupling arrangement, in which the function of the compensation for the axial offset between the two shafts on the one hand and a damping during the transmission of torque on the other are performed by two physically separated damping elements. As a result, the two damping elements can each be individually adapted to their functions, which results in optimization of the coupling arrangement.

The movable bearings of the damping elements disclosed in claims 8 and 9 can be used to easily compensate for the tolerances already mentioned above, such as angular errors and deviations in the axial spacing.

The measure disclosed in claim 10 increases the reliability of the coupling arrangement by virtue of the fact that the radial adjusting screw is secured against loosening from its definite, tensioned state.

According to claim 11, when only one rotation direction is to be transmitted, a free-wheel is integrated into the coupling arrangement. This serves to reduce the rotational irregularity transmitted.

Other features, details, and advantages of the invention ensue from the following description in which exemplary embodiments will be explained in detail in conjunction with the accompanying drawings.

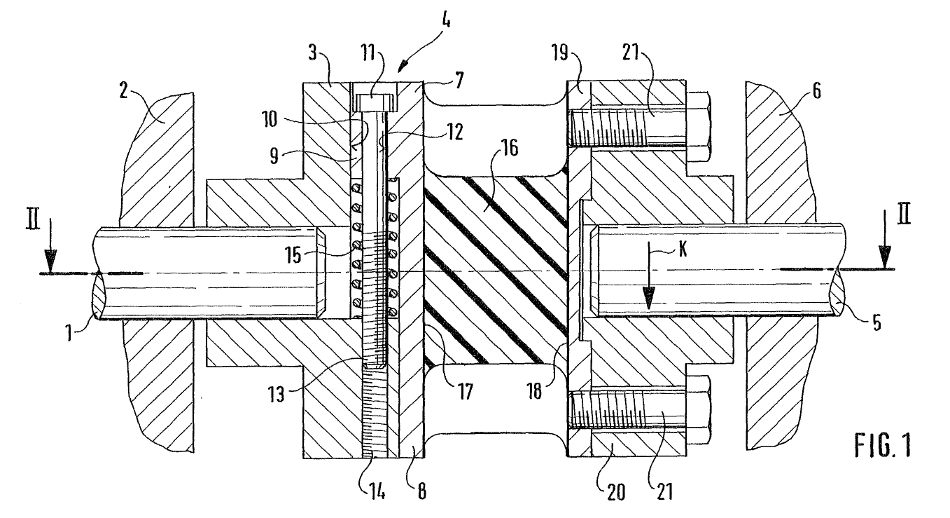

FIG. 1 shows an axial section through a coupling arrangement in a first embodiment,

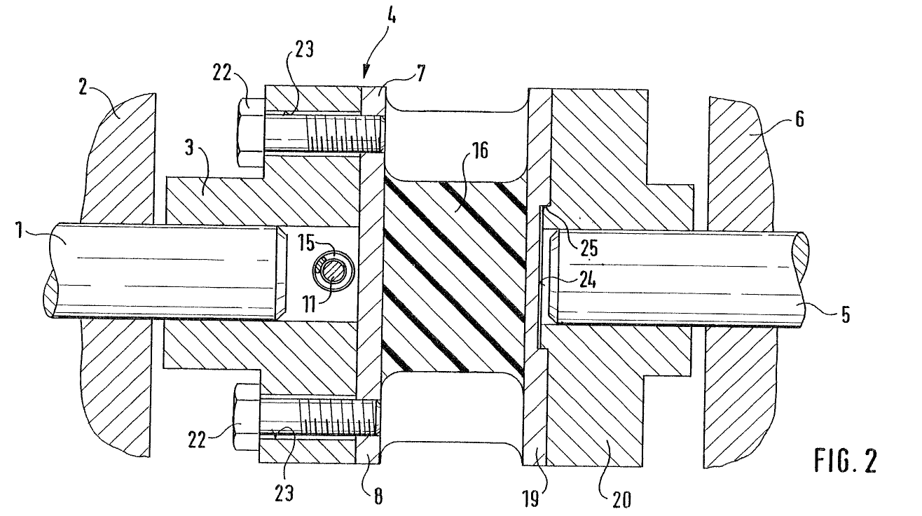

FIG. 2 shows an axial section through this coupling arrangement, along the cutting line II-II according to FIG. 1,

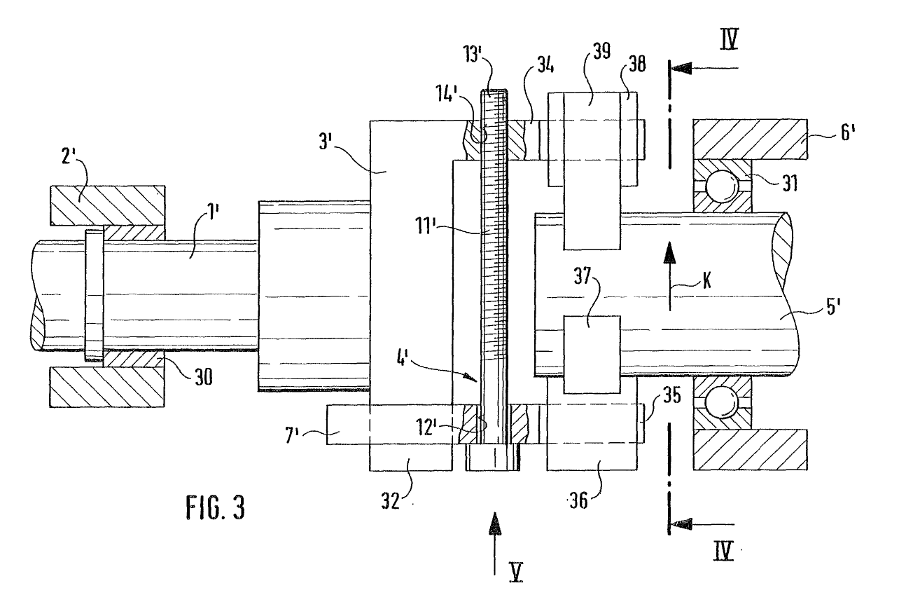

FIG. 3 shows a schematic side view of a coupling arrangement in a second embodiment,

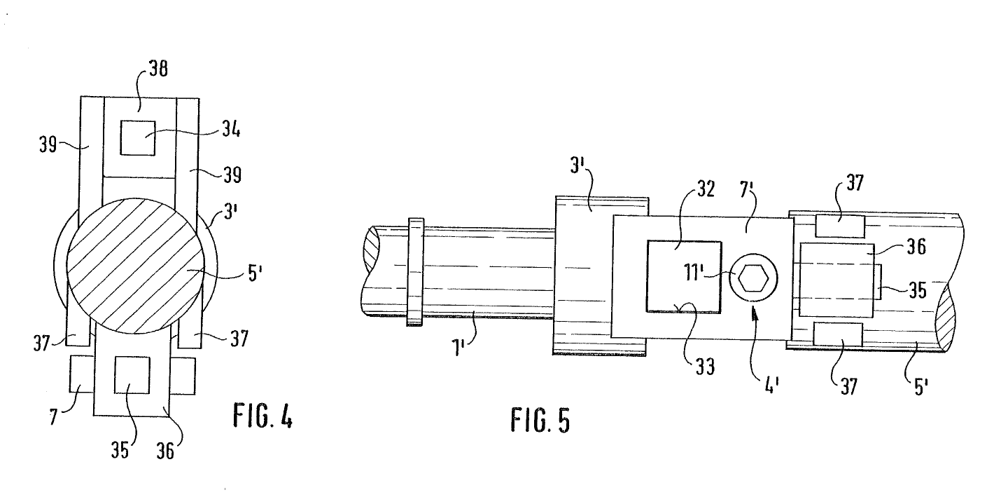

FIG. 4 shows a radial section along the cutting line IV-IV in FIG. 3, and

FIG. 5 shows a view of the coupling arrangement in the direction of the arrow V in FIG. 3.

The coupling arrangement shown in FIGS. 1 and 2 has a drive shaft 1 in a housing 2. The bearing setup of the drive shaft 1 is such that all restoring forces can be absorbed.

The drive shaft 1 non-rotatably supports a driver 3, which is part of a radial tensioning element 4 to be discussed in further detail. The latter is basically used to exert a definite radial force K onto the driven shaft 5, which is disposed spaced axially apart from the drive shaft 1 and belongs to an auxiliary unit of a motor, which auxiliary unit is indicated by the housing 6.

If in addition to the driver 3, the radial tensioning element 4 has a slider 7, which is supported on it in a rotationally fixed manner, but can be slid radially, and which is supported with its flat, plate-shaped part 8 in the axial direction against the driver 3. On the side of the plate-shaped part 8 oriented toward the drive shaft 1, in the radially outer region, a block-like projection 9 is formed onto it and is of one piece with it, which in a transition fit, engages in a radial groove 10 in the axially oriented side of the driver 3. As a result, the slider 7 as a whole is guided so that it can move in the radial direction in relation to the driver 3.

A radial adjusting screw 11 passes through the projection 9 in the radial direction of the coupling arrangement by means of a through opening 12; the threaded end 13 of the radial adjusting screw 11 engages in a radially threaded bore 14 in the driver. A helical compression spring 15, which is “threaded onto” the radial adjusting screw 11, is inserted between the projection 9 and the mouth region of the radial threaded bore 14.

An elastomer damping block 16 is permanently fastened to the side of the plate-shaped part 8 oriented away from the projection 9 by being vulcanized onto it with its proximal axial end 17. With its other axial end 18, the elastomer damping block 16 is vulcanized onto a mounting plate 19, which can be screw connected to a driver 20 that is non-rotatably supported on the driven shaft 5. The axially parallel bolts 21 provided for this are shown in FIG. 1.

Correspondingly, the slider 7 can be screwed in place in a certain radial position by means of axially parallel bolts 22. These bolts 22 pass through oblong hole-shaped openings 23 so that the sliding freedom of the slider 7 required for the radial offset can be achieved. On the other side at the axial end 18, the mounting plate 19 is provided with a central recess 24, which cooperates with an annular collar 25 on the driver 20 and thus achieves a centering of the damping block 16.

In addition to the radial tensioning of the coupling arrangement according to FIGS. 1 and 2, the purely radial mountability of the coupling arrangement is significant for production engineering reasons. This can be explained as follows:

During assembly, it is assumed that the housing 2 has already been installed in stationary fashion and the housing 6 has yet to be mounted. The drive shaft 1 is supported in the housing 2 and the drive 3 is mounted onto it in a rotationally fixed manner, for example by means of frictional engagement in the form of a press fit or by means of positive engagement in the form of a profiled connection.

On the side of the housing 6, the driver 20 is mounted onto the driven shaft 5, which is rotatably supported in the housing 6. With the aid of the two bolts 21, the mounting plate 19, the elastomer damping block 16, and the slider 7 are already screwed tightly to the driver 20.

For installation, the drive shaft 1 is rotated so that the radial groove 10 in the driver 3 points in the radial assembling direction. The helical compression spring 15 is inserted into the radial groove 10. The completely preassembled unit comprised of the slider 7, damping block 16, mounting plate 19, driver 20, driven shaft 5, and housing 6 of the auxiliary unit is radially inserted, the slider 7 traveling with its projection 9 in the radial groove 10. The radial adjusting screw 11 is slid through the through opening 12 and is rotated into the radial threaded bore 14 and screwed in until the desired offset of the coupling between the drive shaft 1 and the driven shaft 5 is achieved. The offset depends on the radial rigidity of the elastomer damping block 16 and can also be inferred from the characteristic curve of the damping block. In the tensioned state, the radial adjusting screw 11 can be secured against loosening, for example by means of a micro-encapsulation.

After the desired initial tension is set, the two axially parallel bolts 22 are tightened and the driver 3 ends up being connected to the slider 7 in a non-rotatable fashion.

In this state, the axial offset of the drive shaft 1 and driven shaft 5, which is not shown in the drawings, is compensated for by the elastomer damping block 16 in precisely the same manner as the load peaks in the transmission of torque between the drive shaft 1 and the driven shaft 5.

The embodiment shown in FIGS. 3 to 5 in turn has a drive shaft 1′, which is supported in rotary fashion in a housing 2′ by means of a bearing 30. The drive shaft 1′ supports a driver that is labeled as a whole with the numeral 3′, which is in turn provided for producing a radial offset between the drive shaft 1′ and driven shaft 5′ by means of a radial spanning element labeled as a whole with the numeral 4′. This radial offset produces a radial force K on the bearing 31 of the driven shaft 5′ in the housing 6′ of an auxiliary unit that is not shown in detail.

The driver 3′ has a radially extending jaw 32 on which the elongated slider 7′ is guided so that it can move in the radial direction. To that end, the slider 7′ is provided with a square opening 33 (FIG. 5) on this jaw 32.

In addition to the square opening 33, a through opening 12′ is provided for the radial adjusting screw 11′, which engages with its threaded end 13′ in a radial threaded bore 14′ in a cantilever arm 34 extending in the axially parallel direction opposite from the slider 7. The radial adjusting screw 11′ can be used to adjust the slider 7′ in the radial direction.

On the side of the through opening 12′ remote from the square opening 33, the slider 7′ is provided with a square projection 35, onto which is slid an essentially block-shaped radial damping element 36 in the form of an elastomer block. The side of the radial damping element 36 pointing radially inward is supported against the circumference surface of the driven shaft 5′. In order to laterally guide the radial damping element 36 and in order to roughly compensate for an imbalance, guide jaws 37 are provided on the circumference surface of the driven shaft 5′, between which the radial damping element 36 is supported with sufficient lateral play.

An additional elastomer block is slid onto the free end of the cantilever arm 34 and serves as a separate torque-damping element 38 for a damped transmission of torque between the cantilever arm 34 and the driven shaft 5′. To that end, the torque damping element 38, which is embodied as an elastomer block, is inserted with sufficient radial play in relation to the driven shaft 5′, between two receiving walls 39 that protrude from the driven shaft 5′ parallel to each other, by means of which the rotary motion is transmitted from the drive shaft 1′, driver 3′, and torque damping element 38 onto the driven shaft 5′.

It is clear that the radial damping element 36 can be slid in the axially parallel direction on the slider 7′, whereas by sliding the slider 7′ radially inward, the driven shaft 5′ is acted on by the radial damping element 36 and the radial force K is introduced into the bearing 31. The torque damping element 38 in turn is supported so that it can slide in both the radial direction between the receiving walls 39 and in the axially parallel direction on the cantilever arm 34 so that the torque damping element 38 is used exclusively for the spring-assisted transmission of torque and can also compensate for the tolerances discussed at the beginning.

The coupling arrangement according to FIGS. 3 to 5 can also be mounted in a purely radial direction in that the driven shaft 5′ with the housing 6′ can be slid radially onto the preassembled cantilever arm 34 with the torque damping element 38. Then, the slider 7′ with the radial damping element 36 slid onto it can be slid from the outside, likewise in the radial direction, onto the jaws 32 and the radial adjusting screw 11′ can be screwed in and appropriately tensioned. The radial adjusting screw 11′ can be secured against loosening, e.g. by means of a micro-encapsulation.

1. A coupling arrangement for transmitting a torque, comprised of a drive shaft (1, 1′) and a driven shaft (5, 5′), characterized by means of a damping element (16, 36, 38) for compensating for an axial offset between the two shafts (1, 1′; 5, 5′) and a radial tensioning element (4, 4′), which is coupled to the damping element (16, 36, 38) and is for introducing a definite force (K) that acts radially on the driven shaft (5, 5′).

2. The coupling arrangement according to claim 1, characterized in that the radial tensioning element (4, 4′) has a driver (3, 3′) that is non-rotatably attached to the associated shaft (1, 1′), against which driver a slider (7, 7′), which is connected to the damping element (16, 36, 38), is supported in a non-rotatable, but radially movable manner and can be radially adjusted by means of a radial adjusting screw (11, 11′) that engages in the driver (3, 3′).

3. The coupling arrangement according to claim 1 or 2, characterized in that the damping element is an elastomer damping block (16), which is disposed axially between the two shafts (1, 5) and which, in addition to compensating for the axial offset between the shafts (1, 5), simultaneously produces a damping during the transmission of torque.

4. The coupling arrangement according to claim 3, characterized in that on its one axial end (17), the elastomer damping block (16) is permanently connected to the provided plate-shaped slider (7) of the radial tensioning element (4) and at its other axial end (18), the elastomer damping block is permanently connected to a mounting plate (19).

5. The coupling arrangement according to claim 4, characterized in that after the radial tensioning force is set the slider (7) and the mounting plate (19) can be respectively mounted non-rotatably and rigidly in the radial direction to the driver (3) of the one shaft (1) and to a support element (20) associated with the mounting plate (19) on the other shaft (5).

6. The coupling arrangement according to one of claims 2 to 5, characterized in that a spring element (15) is disposed between the slider (7) and driver (3) and pushes these two components (3, 7) radially away from each other.

7. The coupling arrangement according to claim 1 or 2, characterized in that in addition to the radially acting radial damping element (36) for compensating for the axial offset, a second, separate torque damping element (38) is provided for damping during the transmission of torque.

8. The coupling arrangement according to claims 2 and 7, characterized in that the radial damping element (36) is supported so that it can slide in the axial direction on the slider (7′) and acts radially on the end surface of the shaft (5′) to be tensioned in the radial direction.

9. The coupling arrangement according to claims 2 and 7, characterized in that the torque damping element (38) is supported so that it can slide axially on the driver (3′) and can slide radially in relation to the shaft (5′) that is acted upon by the radial damping element (36).

10. The coupling arrangement according to at least claim 2, characterized by means of a securing mechanism for the radial adjusting screw (11, 11′), which prevents the screw from loosening when in the tensioned state.

11. The coupling arrangement according to one of claims 1 to 10, characterized in that when there is only one rotational direction to the transmitted, a free-wheel is integrated into the arrangement in order to reduce the rotational irregularity transmitted.
